(19) United States
(12) Patent Application Publication
(10) Pub. No.: US 2023/0039125 A1
(43) Pub. Date: Feb. 9, 2023

(54) PARKING ASSISTANCE SYSTEM

(71) Applicant: Continental Autonomous Mobility Germany GmbH, Ingolstadt (DE)

(72) Inventors: Philipp Kunz, Weiterstadt (DE); Frank Edling, Schealbach (DE)

(73) Assignee: Continental Autonomous Mobility Germany GmbH, Ingolstadt (DE)

(21) Appl. No.: 17/904,759

(22) PCT Filed: Feb. 10, 2021
(86) PCT No.: PCT/DE2021/200012

§ 371 Date: Aug. 22, 2022

(30) Foreign Application Priority Data
Feb. 20, 2020 (DE) 10 2020 202 188.0

(51) Int. Cl. B60W 30/06; B60W 30/16; B60W 30/02; B60W 40/04; B60W 40/12

(52) U.S. Cl. CPC B60W 30/06; B60W 30/16; B60W 30/025; B60W 40/04; B60W 40/12; B60W 2420/42; B60W 2420/52; B60W 2420/54; B60W 2530/201; B60W 2554/80

(57) ABSTRACT

The invention relates to a parking assistance system for an ego vehicle (1), comprising a control device (2) for controlling a parking procedure, in which the ego vehicle (1) is guided to a target position within a parking space (10), the control device (2) can access sensors for environment detection and, on the basis of the sensor data, can determine a parking space (10) by identifying objects (10a, 11, 12, 13) surrounding the parking space (10), wherein the control device (2) is designed to specify a first minimum distance and a second minimum distance of the ego vehicle (1) from surrounding objects (10a, 11, 12, 13), the control device (2) is furthermore designed to specify, on the basis of the first minimum distance, a first parking region (14) and, on the basis of the second minimum distance, a second parking region (15), and the control device (2) determines the target position by specifying said position within the first and/or the second parking region (14, 15).

### CROSS-REFERENCE TO RELATED APPLICATIONS

The present application is a National Stage Application under 35 U.S.C. § 371 of International Patent Application No. PCT/DE2021/200012 filed on Feb. 10, 2021, and claims priority from German Patent Application No. 10 2020 202 188.0 filed on Feb. 20, 2020, in the German Patent and Trade Mark Office, the disclosures of which are herein incorporated by reference in their entireties.

### FIELD OF INVENTION

The present invention relates to a parking assistant or a parking assistance system as well as a method for controlling a parking procedure, which is affected in particular by a parking assistant. The present invention furthermore relates to a vehicle which has a parking assistance system and/or applies a method in order to control a parking procedure as well as a computer program for performing the method and a transportable computer-readable storage medium, on which the computer program for performing the method is stored.

### BACKGROUND

Generic vehicles such as, e.g., passenger vehicles (cars), trucks or motorcycles, are increasingly equipped with driver assistance systems which, with the aid of sensor systems, can detect the environment, identify traffic situations and support the driver, e.g., by a braking or steering intervention or by outputting a visual, haptic or acoustic warning. Radar sensors, lidar sensors, camera sensors, ultrasonic sensors or the like are regularly deployed as sensor systems for environment detection. Conclusions can subsequently be drawn about the environment from the sensor data established by the sensors, with which, e.g., a so-called surroundings model can also be generated. Based thereon, instructions for warning/informing the driver or for regulating the steering, braking and acceleration can subsequently be output. Thanks to the assistance functions which process sensor and surroundings data, e.g., accidents with other road users can be avoided or complicated driving maneuvers can, as a result, be facilitated by supporting or even completely taking over the driving task or driving of the vehicle (in a partially or fully automated manner). For example, the vehicle can perform Autonomous Emergency Braking (AEB) e.g., by means of an Emergency Brake Assist (EBA), control the speed and distance when following vehicles by means of Adaptive Cruise Control (ACC), or keep the vehicle in its lane by means of a steering assistant (LKA, Lane Keep Assist). Furthermore, partially or fully automated parking procedures are performed by means of a parking assistant, during which the driver of the vehicle is supported or replaced when parking in a parking space.

Such parking assistants or parking assistance systems can initially detect the parking space by means of environment-identifying sensor technology and define the final position of the ego vehicle within the parking space (target pose or target position), wherein the target position of the vehicle is, as a general rule, centered in the parking space. In addition, other target positions can also be provided in order to adapt to special parking situations such as incorrectly aligned vehicles in the adjacent parking spaces. For example, a percentage positioning in the parking space can also be defined, e.g., a vehicle can provide 30% of the free space in the parking space in front of the ego vehicle and 70% of the free space in the parking space behind the ego vehicle. The alignment of the ego vehicle in the target position can additionally be defined by further boundary markings such as, e.g., surface markings, corner stones, curbs or the like.

In standard parking situations, simple rules (centering, percentage positioning) can be used in order to park the vehicle. However, such adaptations are either ignored for certain situations, which leads to a counterintuitive positioning in the parking space, or additionally implemented, which necessitates a high computational cost and very complex and poorly maintainable source code at programming level. With respect to the orientation of the ego vehicle, a misalignment of the other vehicles parked next to the free parking space can also lead to an incorrect orientation of the ego vehicle at the target position. Moreover, the parking maneuver should be ended by the parking assistant in a parking position, in which certain safety regions with respect to other vehicles, curbs, walls and other high and low objects are observed in order to avoid collisions and vehicle damage. At the same time, however, comfort requirements should also be met when parking, which require a certain amount of space such as, e.g., loading and unloading the trunk, all of the passengers getting in or out of the vehicle without problems or the like. In addition, the alignment of the ego vehicle at the target position should prevent a misalignment of other vehicles.

A method for assessing a region for parking a vehicle is known from DE 10 2014 206 235 A1, in which a host vehicle is parked by means of an active parking assistant. The parking assistant recognizes, by means of suitable sensor technology, a parking space which is delimited by objects, e.g., by parked vehicles or a curb. The vehicle is positioned in a centered position between surrounding objects such as, e.g., the vehicles, or, in general, in accordance with the curb and/or the roadway. The disadvantage in this case is that the host vehicle is constantly parked in a centered position and any comfort requirements of the driver are not addressed. Furthermore, the orientation of other vehicles, which are not always precisely aligned, can result in difficulties or collisions when maneuvering the host vehicle into or out of a parking space.

### SUMMARY

Starting from the prior art, the present disclosure provides a method by which a generic driver assistance system may be simply and inexpensively improved in such a way that the disadvantages of the prior art are overcome, so that a space-saving or space-optimized as well as a safe parking procedure is made possible.

The aforementioned disadvantages are addressed by the entire teaching of claim 1 as well as the alternative independent claim. Expedient configurations of the invention are set out in the subclaims.

According to the present disclosure, the parking assistance system for an ego vehicle includes a control device for controlling a parking procedure, which may guide the ego vehicle to a target position within a parking space. Moreover, the control device may access sensors for environment detection and, on the basis of the sensor data, may determine a parking space by identifying and evaluating or classifying objects surrounding the parking space. Furthermore, the control device is designed to specify or to calculate a first minimum distance and a second minimum distance of the ego vehicle from surrounding objects. The control device specifies, on the basis of the first minimum distance, a first parking region (e.g., a maximum parking region in order to prevent collisions) and, on the basis of the second minimum distance, specifies a second parking region (e.g., a comfort parking region in order to fulfil comfort requirements). Following this, the control device may then determine the target position by specifying it within the first and/or the second parking region. This results in the advantage that only a single parking concept is required, with which multiple different requirements may be covered by taking them into account at various spacings or distances from the surrounding objects and carrying out a human-like positioning by taking into account collision-avoiding as well as comfort-increasing aspects. As a result, space may be saved to a particular extent when parking, as a result of which space may be gained or the space requirement is reduced. Moreover, the acceptance of the parking procedure affected by the parking assistant or of the target position specified as a result on the part of the driver of the ego vehicle is increased, since this target position also takes the driver's comfort requirements into account.

The first minimum distance may be a distance which should or must be present between the ego vehicle and the surrounding objects, in order to avoid a collision of the ego vehicle with the surrounding objects, i.e., a minimum distance of a few centimeters or millimeters, such as 1 to 5 decimeters, so that collisions of the ego vehicle may be avoided. This particularly increases the safety of the parking procedure.

It is particularly advantageous if the second minimum distance is a distance which should be present between the ego vehicle and the surrounding objects in order to guarantee various comfort functions such as, e.g., all of the passengers getting in or out of the vehicle or loading the trunk. To this end, sufficient distance must be available. This distance may be calculated, e.g., based on the geometry of the ego vehicle. For example, a distance could be chosen which makes it possible to open the doors of the ego vehicle or the trunk without obstacle, i.e., the distance is, e.g., the length of a vehicle door. However, it may also be a fixed distance value, e.g., 30, 50, 80 or 100 centimeters.

The second minimum distance may, furthermore, be specified in such a way that this is larger than the first minimum distance by a percentage value, or multiple times larger, e.g., 10%, 20%, 50%, 100%, 150%, 200%, 500% larger than the first minimum distance or 5, 10, 50, 100, 500 times the value of the first minimum distance.

Expediently, the first and/or second minimum distance may be the same size on all sides of the ego vehicle or may vary side by side in accordance with the geometry of the ego vehicle or even include a range, i.e., the second minimum distance may, e.g., be 50-100 cm in the front region and 10-30 cm in the side region, as a function of the surrounding objects. For example, more space may be provided at the front and the rear of the ego vehicle, i.e., a larger minimum distance, than at the vehicle sides in order, e.g., to facilitate the loading and unloading of the trunk or access to the hood and, at the same time, to park close to the curb. In addition to increasing the safety of the parking procedure, the space required by a parking vehicle may also be reduced or optimized by adapting the minimum distances in a targeted fashion.

Moreover, the control device may, in addition to the first and second minimum distance, specify further minimum distances, e.g., one or more minimum distances as intermediate steps between the first and second minimum distance so that, accordingly, further parking regions are specified, which may be enlisted to determine the target position.

At least one radar, lidar, camera or ultrasonic sensor may be provided as the sensor or sensors for environment detection. In addition, a fusion of the individual sensor data may be affected, e.g., within the control device, in order to improve the environment detection even further.

An object classification may be expediently affected, wherein the identified objects or the objects surrounding the parking space are classified (e.g., vehicle, wall, tree, guardrail, curb, road marking, sign and the like). A classification of the parking space is affected by the object classification and/or the established geometry of the surrounding objects (height, width and the like), e.g., as a longitudinal parking space, transverse parking space, oblique parking space, disabled parking space (due to wider dimensions and/or a traffic sign identification, e.g., by means of a camera), duplex parking space, truck parking space, bus parking space, electric charging parking space or the like. The minimum distances or parking regions may then be advantageously specified or varied on the basis of the parking space classification, in particular independently or automatically. For example, if a longitudinal parking space is identified, more space may be provided in the front and rear region of the ego vehicle in order to facilitate the maneuvering and to guarantee that the ego vehicle is not parked on the curb when the longitudinal parking space is on a road. Furthermore, in the case of an electric charging parking space, provision may be made for sufficient access to be provided to the charging plug at the charging station and/or ego vehicle. Moreover, larger minimum distances from the sides of the vehicle may be provided in transverse and oblique parking spaces than in the front or rear region of the ego vehicle in order to facilitate getting in and out of the vehicle. The object and/or parking space classification may likewise be affected by the control device by the latter evaluating and processing the sensor data on the basis of a (in particular software-implemented) classifier or by another classification unit provided for this purpose.

An orientation angle of the parking spot or parking space is determined from the following features, in particular in the following priority (if these are available): parking bay marking(s), curb(s), parked vehicles, other objects (e.g., building edges, vegetation, traffic signs or the like), vehicle orientation of the ego vehicle when driving past.

In a practical way, the control device may access actuators of the ego vehicle in order to carry out the parking procedure independently. As a general rule, the brakes, the transmission, the engine or the steering are provided as actuators, however other actuators of the vehicle may also be actuated.

The present disclosure furthermore includes an ego vehicle which includes a parking assistance system according to the present disclosure in order to support the driver in a fully or partially automated manner during parking so that the driver, e.g., actively operates actuators, after the parking assistance system has transmitted an instruction (e.g., “steering angle to the left or right”, “throttle”, “braking” and the like) to the driver to this end, or the driver no longer has to operate any controls and the parking procedure is affected independently or automatically.

The present disclosure also claims, in an alternative independent claim, a method for controlling a parking procedure of an ego vehicle, in which the ego vehicle is guided to a target position within a parking space. To this end, sensor data from suitable sensors for environment detection are enlisted in order to determine the parking space by identifying objects surrounding the parking space. A first minimum distance and a second minimum distance of the ego vehicle from surrounding objects are specified. Following this, a first parking region may then be specified on the basis of the first minimum distance, and a second parking region may be specified on the basis of the second minimum distance. The target position of the ego vehicle is then determined by specifying this within the first and/or the second parking region.

The method may expediently include the following method steps:
method step 1: determining an orientation angle of the ego vehicle in the target position by prioritizing the surrounding objects,
method step 2: determining the first and second parking region by checking the environment for necessary minimum distances and for suitable comfort distances, and
method step 3: selecting a point of the second parking region in order to position the ego vehicle with the orientation calculated in method step 1 based on the location of the surrounding objects and markings.

According to a particular configuration of the method, a point of the first parking region may be selected in method step 3, so that the target position of the ego vehicle is also adjusted on the basis of the selected point of the first parking region if the target position could not be specified on the basis of the selected point of the second parking region. The first parking region, i.e., the maximum parking region, is fallen back on, so to speak, as soon as the comfort parking region cannot be specified or there is insufficient space for it. This results in the advantage that the ego vehicle independently parks in the maximum parking region if the comfort parking region cannot be achieved or the extent of the parking space is too small in order to choose the comfort parking region.

Furthermore, a point of the first parking region may also be selected in the third method step, wherein the target position of the ego vehicle is then simultaneously adjusted on the basis of the selected point of the first and of the second parking region.

The present disclosure furthermore includes a computer program having program code for performing the method according to the present disclosure when the computer program is run on a computer or another programmable computing device known from the prior art. Accordingly, the method may also be configured as a purely computer-implemented method, wherein the term “computer-implemented method” describes, in the context of the present disclosure, a sequencing or course of action which is realized or performed on the basis of a computing device. The computing device such as, e.g., a computer, a computer network or another programmable device known from the prior art (e.g., a computing device including a processor, microcontroller or the like) may process data by means of programmable calculation specifications.

Moreover, the present disclosure includes a computer-readable storage medium which includes instructions which prompt the computer on which they are run to perform a method according to at least one of the preceding claims.

### BRIEF DESCRIPTION OF THE DRAWINGS

The invention is explained in greater detail below with reference to expedient exemplary embodiments, wherein:

FIG. 1 shows a considerably simplified schematic representation of an ego vehicle having an assistance system according to the invention;

FIG. 2a shows a simplified representation of a traffic scenario, in which an ego vehicle having an assistance system according to the invention detects a parking space;

FIG. 2b shows a simplified representation of a traffic scenario, in which an ego vehicle having an assistance system according to the invention detects a parking space, wherein the parking space is delimited by parking space markings as well as the curb;

FIG. 3a shows a simplified representation of the traffic scenario from FIG. 2a, in which the vehicle has reached the target position in the parking space on the basis of the assistance system according to the invention, and

FIG. 3b shows an enlarged representation of the traffic scenario from FIG. 3a.

### DETAILED DESCRIPTION

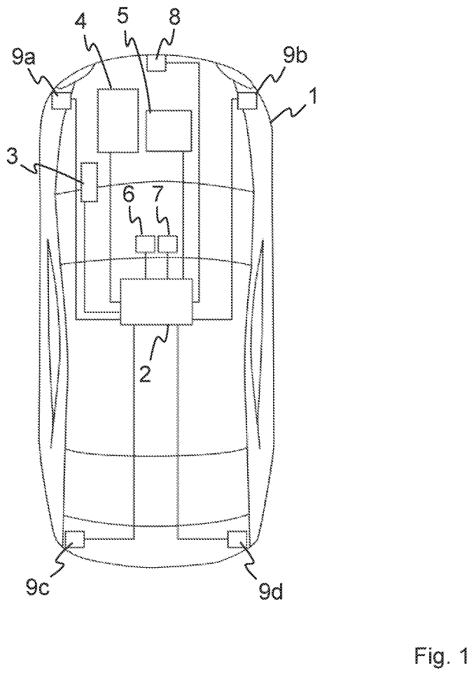

Reference numeral 1 in FIG. 1 designates a vehicle or ego vehicle having various actuators (steering 3, engine 4, brake 5), which has a control device 2 (ECU, Electronic Control Unit or ADCU, Assisted and Automated Driving Control Unit) which may control the ego vehicle 1 in a (partially) automated manner by the control device 2 being able to access the actuators. Furthermore, the ego vehicle 1 has sensors for environment detection (camera 6, lidar sensor 7, radar sensor 8 as well as ultrasonic sensors 9a-9d), the sensor data of which are utilized in order to identify the surroundings and objects, so that various assistance functions such as, e.g., a parking assistant, Electronic Brake Assist (EBA), Adaptive Cruise Control (ACC), Lane Keep Assist (LKA) or the like may be realized. The assistance functions are executed via the control device 2 or the algorithm stored there.

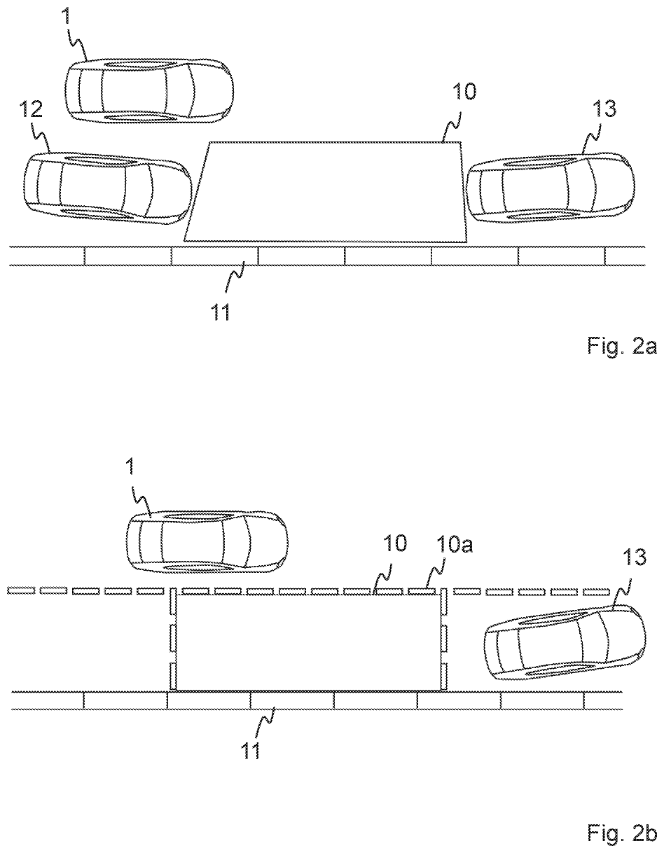

FIG. 2a shows a traffic scenario, in which the ego vehicle 1 is driving along a road which is delimited on the right-hand side by a curb 11. Furthermore, two parked vehicles 12, 13 are located on the right-hand side of the road, between which there is a parking spot or a parking space 10. The parking space 10 is a longitudinal parking space which is delimited by multiple limiting elements, i.e., by the parked vehicles 12, 13 as well as the curb 11 or border stone. Furthermore, other limiting elements could also delimit the parking space 10 such as, e.g., parking space markings 10a (according to FIG. 2b) or surface markings, walls, vegetation, fences or other undefined high/low objects. The ego vehicle 1 includes a control device 2 according to the present disclosure or a parking assistance system according to the present disclosure as well as suitable sensors for environment detection, by means of which the ego vehicle 1 may detect the environment as well as objects located therein (the control device and the sensors are not depicted in FIGS. 2a/2b for the sake of clarity). As a result, the ego vehicle 1 may detect the surrounding objects and, therefore, the parking space 10 as it drives past and may start or perform a parking procedure, wherein distance or space restrictions may be translated on the basis of the method according to the present disclosure, so that both safety and comfort requirements are taken into account in one concept.

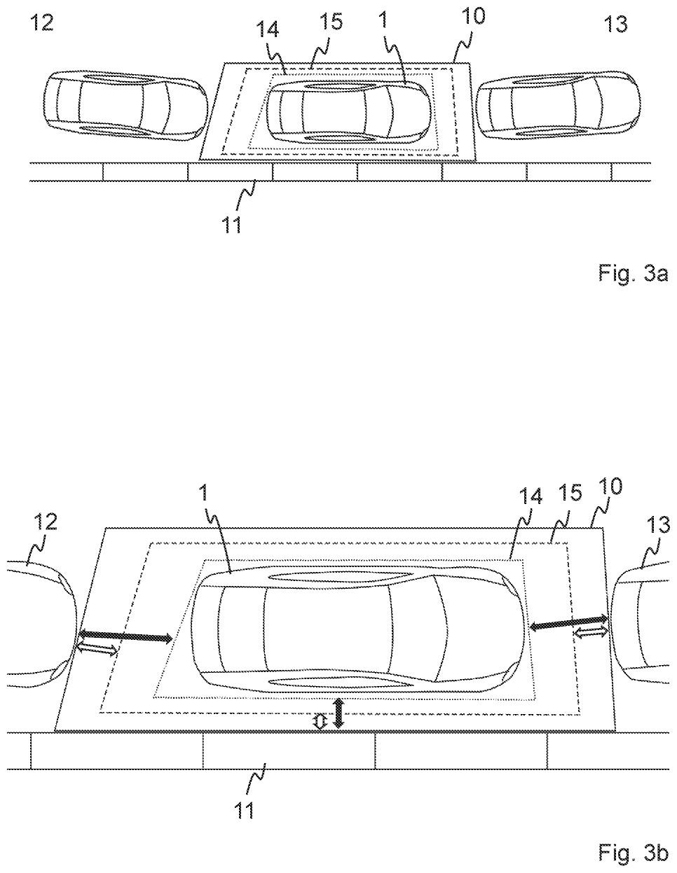

The traffic scenario from FIG. 2a is now depicted in FIGS. 3a and 3b, wherein the ego vehicle 1 is located in the target position in the parking space 10. The spacings from the surrounding objects are divided into a first minimum distance, i.e., the minimum clearance which is necessary in order to avoid collisions, and a second minimum distance, i.e., the comfort clearance or the comfort distance, which is required in order to guarantee comfort requirements (getting in and out of the vehicle, loading and unloading and the like). In FIG. 3b, the first minimum distance or the minimum clearances are depicted with white arrows and the second minimum distance or the comfort clearances are depicted with black arrows. The fact that the minimum clearances have to be observed in order to avoid collisions means that these are not allowed to be violated or fallen short of when specifying the target position. Comfort clearances, on the other hand, offer sufficient space in order to observe comfort requirements, so that these may be violated or fallen short of if there is not enough space available and the parking requirement exceeds the comfort requirements. Consequently, when there is a parking space, two parking regions 14, 15 are determined on the basis of the minimum distances, i.e., a first parking region 14 having the minimum required spacing from the surrounding objects and a second parking region 15 having a spacing from the surrounding objects which makes possible comfortable utilization of the parking space. As a consequence, two virtual parking spaces or parking regions 14, 15 are therefore calculated, wherein the first parking region 14 having the minimum required spacings from surrounding objects (first minimum distance) may also be referred to the so-called maximum parking space, and the second parking region 15 having the comfort spacings (second minimum distance) may be referred to as the comfort parking space. If multiple delimiting elements or surrounding objects are present on an edge or a side of the ego vehicle 1, the maximum required distance from a boundary element or object on this side is always relevant for the specification of the first and second parking regions 14, 15.

The target position of the maximum parking space or comfort parking space may be expediently achieved on the basis of the (multi-step) course of the method according to the present disclosure. For example, as a first step, the orientation angle of the target position may initially be determined or calculated by selecting the objects delimiting or surrounding the parking space by prioritizing, e.g., on the basis of a priority list (for example, the priority may include the following in descending order of importance: surface identification, curb, detected objects as well as ego vehicle alignment during the parking maneuver), wherein the alignment of the surrounding objects may also be used. A delimiting object is only considered to be “valid for the alignment” if the resulting alignment of the ego vehicle 1, when passing the parking space 10, does not exceed a threshold value compared to the ego vehicle alignment. The first existing and valid object in the priority list is then adopted. Following this, all of the other identified parked vehicles in the same parking row may then be used in order to define the orientation on the priority level (parked vehicles), so that the robustness is further increased with respect to incorrectly aligned vehicles. In a practical manner, the average orientation of all of the valid (“valid for the orientation” as defined above) parked vehicles may also be used in order to specify the orientation of the ego vehicle 1 in the target position. As a second step, a corner or a point of the comfort parking region is then chosen based on the positions of the surrounding delimiting objects. The position in this corner may then be defined with the given orientation angle, without violating the limits of the comfort parking region.

Furthermore, if step 2 has failed, for example, in that the limits of the comfort parking region have been violated or fallen short of, a position within the limits of the maximum parking space may be defined. This position is defined by the longitudinal centering and lateral centering between the edges of the maximum parking space if the limits of the comfort parking space are too small in order to be used in each case for each direction. If a positioning within the comfort parking space is possible in one direction, the second step may also only be used for this direction. The centering is also only affected to the extent that the entire comfort parking space is covered in the selected direction. This guarantees a continual change in the target position in the event of continual changes in the surroundings.

In a practical way, the method according to the invention may also be utilized in order to improve other driving and assistance functions such as, e.g., during so-called “garage parking” in order to improve the positioning in the garage, during so-called “trained parking” in order to improve the final positioning at the end of the learned path, or during so-called “valet parking” in order to improve the final positioning in the parking space. Due to the advantageous properties and the versatility of use, the invention consequently represents a very particular contribution in the field of driver assistance systems, in particular of parking assistants.

### LIST OF REFERENCE NUMERALS

1 Ego vehicle
2 Control device

### 3 Steering

### 4 Engine

### 5 Brake

### 6 Camera

7 Lidar sensor
8 Radar sensor
9a-9d Ultrasonic sensors
10 Parking space
10a Parking space marking

### 11 Curb

### 12 Vehicle

### 13 Vehicle

14 First parking region
15 Second parking region

1. A parking assistance system for an ego vehicle, comprising a control device controlling a parking procedure in which the ego vehicle is guided to a target position within a parking space,
the control device can accesses sensors for environment detection and, on the basis of the sensor data, determines a parking space by identifying objects surrounding the parking space, wherein
the control device is configured to specify a first minimum distance and a second minimum distance of the ego vehicle from surrounding objects,
the control device is furthermore configured to specify, on the basis of the first minimum distance, a first parking region and, on the basis of the second minimum distance, a second parking region, and
the control device determines the target position by specifying said position within the first and/or the second parking region.

2. The parking assistance system according to claim 1, wherein the first minimum distance is a distance which must be present between the ego vehicle and the surrounding objects in order to avoid a collision of the ego vehicle with the surrounding objects.

3. The parking assistance system according to claim 1, wherein the second minimum distance is a distance which should be present between the ego vehicle and the surrounding objects in order to guarantee comfort functions.

4. The parking assistance system according to claim 1, wherein the second minimum distance is larger than the first minimum distance by a percentage value.

5. The parking assistance system according to claim 1, wherein at least one of the first or second minimum distance is the same on all sides of the ego vehicle or varies side by side in accordance with the geometry of the ego vehicle.

6. The parking assistance system according to claim 1, wherein in addition to the first and second minimum distance, further minimum distances and/or further parking regions are specified.

7. The parking assistance system according to claim 1, wherein at least one camera, lidar, radar, or ultrasonic sensor is provided as the sensor or sensors for environment detection.

8. The parking assistance system according to claim 1, wherein a classification of the parking space is affected and the minimum distances or parking regions are specified on the basis of the classification.

9. The parking assistance system according to claim 1, wherein an orientation angle of the parking space is determined from the following features: parking space marking, curb parked vehicles, other objects, vehicle orientation of the ego vehicle when driving past.

10. The parking assistance system according to claim 1, wherein the control device accesses actuators of the ego vehicle and carries out the parking procedure independently.

11. A method for controlling a parking procedure of an ego vehicle, in which
guiding the ego vehicle to a target position within a parking space,
enlisting sensor data from sensors for environment detection in order to determine the parking space by identifying objects surrounding the parking space, wherein
specifying a first minimum distance and a second minimum distance of the ego vehicle from the surrounding objects,
on the basis of the first minimum distance, specifying a first parking region and, on the basis of the second minimum distance, specifying a second parking region, and
determining the target position by specifying the position within the first and/or the second parking region.

12. The method according to claim 11, wherein the method furthermore comprises the following method steps:
determining an orientation angle of the ego vehicle in the target position by prioritizing the surrounding objects,
determining the first and second parking regions by checking the environment for necessary minimum distances and for suitable comfort distances from the surrounding objects, and
selecting a point of the second parking region in order to position the ego vehicle on the basis of the orientation angle.

13. A computer program having program code for performing the method according to claim 11 when the computer program is run on a computer.

14. A computer-readable non-transitory storage medium comprising instructions which prompt the computer on which they are run to execute the method according to claim 11.

15. A vehicle, comprising
a parking assistance system according to claim 1.

16. The parking assistance system according to claim 1, wherein an orientation angle of the parking space is determined from the following features appearing in decreasing priority: parking space marking, curb, parked vehicles, other objects, vehicle orientation of the ego vehicle when driving past.
